(19) United States
(12) Patent Application Publication
(10) Pub. No.: US 2006/0216595 A1
(43) Pub. Date: Sep. 28, 2006

(54) Battery assembly having improved lug profile

(76) Inventors: Rex W. Holliday, Fishers, IN (US); Dane E. Carter, Noblesville, IN (US); Jason E. Connell, Cicero, IN (US); Richard K. Jones, Anderson, IN (US)

Correspondence Address: FOLEY & LARDNER LLP, 777 EAST WISCONSIN AVENUE, MILWAUKEE, WI, 53202-5306, US

(21) Appl. No.: 11/086,822

(22) Filed: Mar. 22, 2005

(51) Int. Cl. H01M 2/26

(52) U.S. Cl. 429/211; 429/161

(57) ABSTRACT

A battery plate is used with a battery. The battery plate includes aplate body extending across the battery. A lug extends out from the plate body to be electrically connected to the battery. The lug defines a surface area and a width. The lug also includes a corrugated portion which increases the surface area of the lug as a function of the width of the lug.

### BACKGROUND ART

1. Field of the Invention

The invention relates generally to batteries. More specifically, the invention relates to batteries having battery plates with lugs designed to facilitate a reduction in the weight thereof.

2. Description of the Related Art

Lead-acid batteries use electrochemical materials, namely materials that produce electrical energy when exposed to electrolytes, to generate electrical current. In lead-acid batteries, lead is formed into plates that are soldered together to form positive and negative electrodes. The positive and negative electrodes are interleaved to form a battery cell. Separators are placed between the electrodes, and the cell is placed in a container or case along with other cells connected, in series or parallel, to provide a battery having desired current and voltage capabilities. The electrolyte is placed in the container with the cells.

The cells are connected together using lead connections, commonly referred to as straps. These straps are cast onto lugs formed from the plates. As may be appreciated, the lead straps and lead plates are heavy. Reducing the weight of a lead-acid battery, while maintaining the performance characteristics of the battery are desired.

### SUMMARY OF THE INVENTION

A battery plate is used with a battery. The battery plate includes a plate body extending across the battery. A lug extends out from the plate body to be electrically connected to the battery. The lug defines a surface area and a width. The lug also includes a corrugated portion which increases the surface area of the lug as a function of the width of the lug.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of one embodiment of a battery, partially cut away, incorporating the invention;

FIG. 2 is a perspective view of a top portion of a battery plate and lug after an initial cut and prior to it being pressed into its final form;

FIG. 3 is a plan view of the top portion of the battery plate of FIG. 1;

FIG. 4 is a perspective view of the top portion of the battery plate and lug in a finished form;

FIG. 5 is a plan view of the top portion of the battery plate and lug of FIG. 4; and

FIG. 6 is a perspective view, partially cut away, of a plurality of plates incorporating the invention secured together with a strap, shown in phantom.

### DETAILED DESCRIPTION OF THE PREFERRED EMBODIMENT

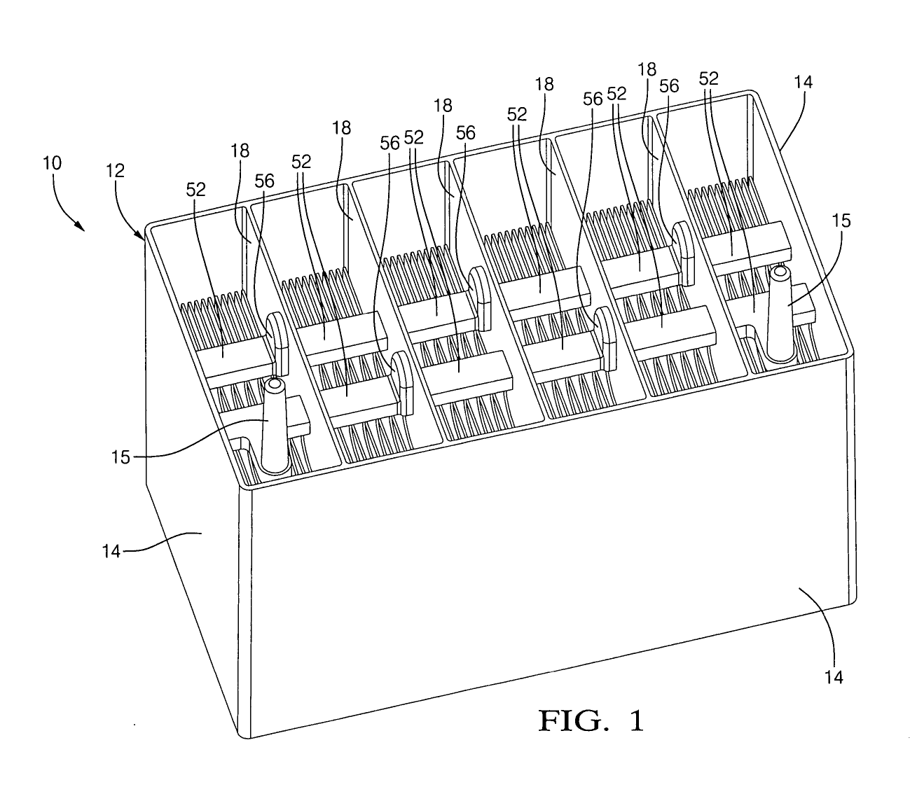

Referring to FIG. 1, a perspective view of a battery assembly is generally indicated at 10. The battery assembly 10 includes a casing, generally shown at 12, having four sides 14. A top to the casing 12 is not shown for the purpose of simplifying the Figure. Two posts 15 extend up to the top for connection to the electrical system of the host device.

The battery assembly 10 also includes a plurality of spacing plates 18. The spacing plates divide the interior of the casing 12 and allow interior components (discussed below) to be supported thereby.

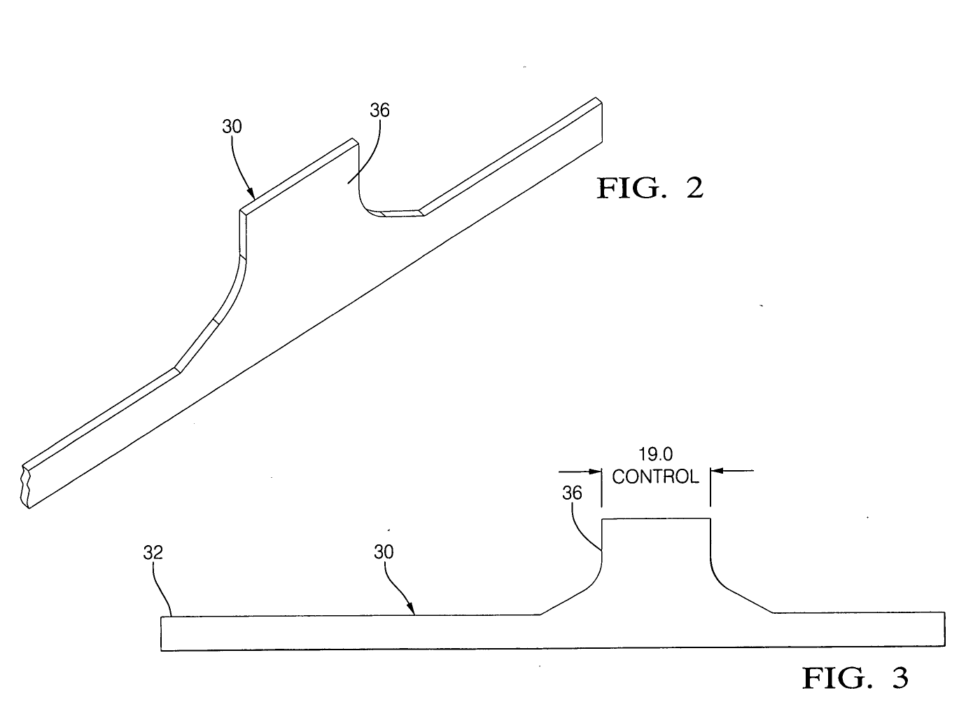

Referring to FIGS. 2 and 3, a cut away perspective view of a top portion of a battery plate is generally shown at 30. A bottom portion of the battery plate 30 is not shown in any of the Figures for purposes of simplicity. It should be appreciated by those skilled in the art that the bottom portion of the battery plate 30 is rectangular in shape and extends down through the casing 12 of the battery assembly 10 as do battery plates known in the art.

The battery plate 30 is shown in its initial cut in FIGS. 2 and 3. This cut is similar to what can be found in the prior art. The battery plate 30 includes a plate body 32 and a lug 36. The plate body 32 and lug 36 extend through the same plane. Referring to FIG. 3, it can be shown that the lug 36 has a width of 19.0 millimeters. In addition, the surface area of the lug 36 is 21 millimeters squared.

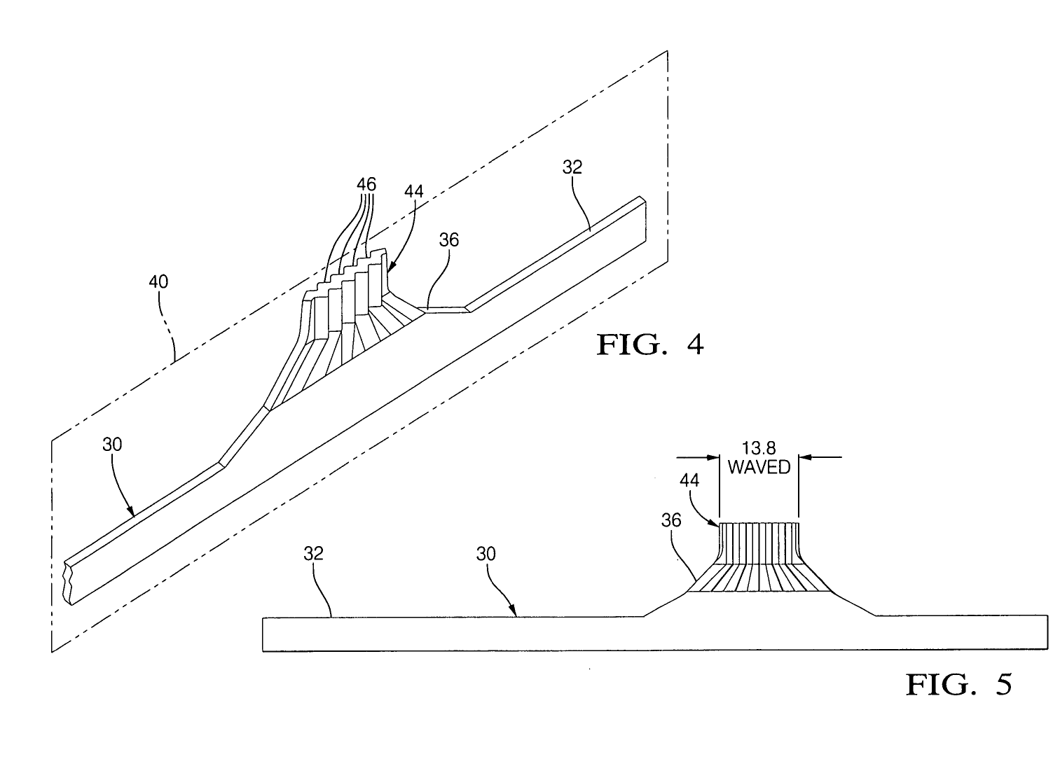

Referring to FIGS. 4 and 5, the battery plate 30 and lug 36 are generally shown in their finished form. The battery plate 30 includes a plate body 32 that extends through a plane 40.

The lug 36 that extends out from the plate body 32 is shown in its final form in FIGS. 4 and 5. In the embodiment shown in these Figures, the lug 36 and the plate body 32 are fabricated from the same piece of lead. It should be appreciated by those skilled in the art that the lug 36 and the plate body 32 may be fabricated through means other than a single forming process.

The lug 36 includes a corrugated portion, generally shown at 44. The corrugated portion 44 is an upper portion of the lug 36. The corrugated portion 44 includes a plurality of corrugations 46. Each of the plurality of corrugations 46 extends out of each other. The corrugations 46 are formed in accordion-style fashion to form ribs that extend in parallel to each other.

Referring to FIG. 5, a plan view of the plate body 38 and lug 36 are shown. The lug 36 has a width 48 that is 13.8 millimeters in width. While the width 48 is less than the width of the lug 36 prior to the final forming step, the lug 36 defines a surface area 50 that is equal to the surface area of the lug 36 prior to finishing. Regardless of the fact that the width 48 of the lug 36 has been reduced, the surface area 50 of the lug 36 remains the same.

The corrugations 46 are centered about the plane 40. Said another way, half of the surface area of the corrugations 46 extend on one side of the plane 40 whereas the other half of the surface area for each of the corrugations 46 extends on the other side of the plane 40. Therefore, the plane 40 bisects each of the corrugations 46. In the preferred embodiment, the plane 40 is defined by the plate body 38.

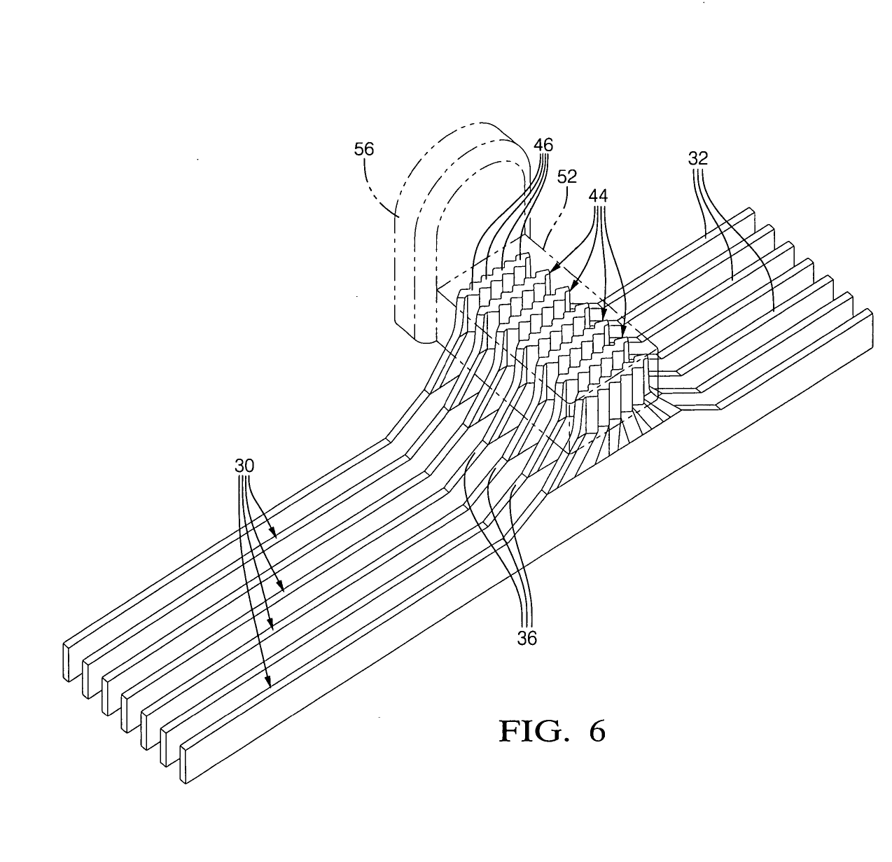

Referring to FIG. 6, a plurality of battery plates 30 are shown connected together by a strap 52. The strap 52 is made of lead and is cast on the lugs 36 of each of the battery plates 30. The strap 52 is thick and heavy, due to its dimensions and lead composition. In a typical battery assembly, there are twelve straps 52. This adds considerable weight to the battery assembly 10. By reducing the width 48 of the lugs 36, the straps 52 define a strap width 54 which is less than the strap width required to cover non-corrugated lugs. Each of the straps 52 have a tombstone 56 extending out and away from the strap 52. The tombstones 56 provide additional support and area to which the straps 52 and the spacing plates 15 may be secured there against.

Continuing with exemplary dimensions set forth above, a reduction of the strap width 54 of the strap 52 to only cover the lugs 36 having a width 48 of 13.8 millimeters results in a reduction of weight in the order of 0.4 pounds. The reduction in weight per battery assembly 10 is a significant contribution to the reduction of weight of the overall motor vehicle which the battery assembly 10 may be incorporated therein. The cost associated with manufacturing the battery assembly 35 is also reduced due to the amount of lead required to fabricate the straps 52. Therefore, there is a reduction in weight and cost associated with the battery assembly that has a lug surface area 50 that does not compromise the performance of the battery assembly 10 at originally designed.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A battery plate for use in a battery, said battery plate comprising a plate body extending across the battery and a lug extending out from said plate body to be electrically connected to the battery, said lug defining a surface area and width and including a corrugated portion to increase said surface area as a function of said width.

2. A battery plate as set forth in claim I wherein said plate body defines a plane and said lug extends substantially through said plane.

3. A battery plate as set forth in claim 2 wherein said corrugated portion includes a plurality of corrugations.

4. A battery plate as set forth in claim 3 wherein each of said plurality of corrugations is centered about said plane.

5. A battery assembly comprising:
a casing;
a plurality of plates equidistantly spaced apart and extending across said casing to facilitate in the generation of an electric charge;
a plurality of straps electrically connecting said plurality of plates to each other, each of said plurality of straps having a defined width; and
a plurality of lugs fixedly secured to each of said plurality of plates and extending into said plurality of straps, each of said plurality of lugs including a corrugated portion to maximize a surface area contained with each of said plurality of straps.

6. A battery assembly as set forth in claim 5 wherein each of said plurality of plates includes a plate body defining a plane.

7. A battery assembly as set forth in claim 6 wherein each of said plurality of lugs extends through said plane defined by said plate body fixedly secured thereto.

8. A battery assembly as set forth in claim 7 wherein said corrugated portion includes a plurality of corrugations.

9. A battery assembly as set forth in claim 8 wherein each of said plurality of corrugations is centered about said plane.
